(19) United States
(12) Patent Application Publication
(10) Pub. No.: US 2014/0067874 A1
(43) Pub. Date: Mar. 6, 2014

(54) PERFORMING PREDICTIVE ANALYSIS

(71) Applicants: Arindam Bhattacharjee, Bangalore (IN); Abhishek Nagendra, Bangalore (IN); Girish Kalasa Ganesh Pai, Bangalore (IN); Unmesh Sreedharan, Bangalore (IN)

(72) Inventors: Arindam Bhattacharjee, Bangalore (IN); Abhishek Nagendra, Bangalore (IN); Girish Kalasa Ganesh Pai, Bangalore (IN); Unmesh Sreedharan, Bangalore (IN)

(21) Appl. No.: 13/600,265

(22) Filed: Aug. 31, 2012

(51) Int. Cl. G06F 17/30

(52) U.S. Cl. 707/803; 707/E17.044

(57) ABSTRACT

Various embodiments of systems and methods for performing predictive analysis are described herein. In one aspect, the method includes receiving a command for publishing a chain comprising a plurality of components connected together to perform predictive analysis. Based upon the command, a plurality of procedures corresponding to the plurality of components of the chain is generated. The generated procedures are integrated according to an order of connectivity of the components within the chain. A database object including the integrated procedures is generated. The database object is stored within a database. The stored database object is executable for performing predictive analysis.

### BACKGROUND

Predictive analysis enables users to statistically analyze various types of data. Some tools for doing predictive analysis use a pipeline or pipe and filter architecture. An analysis chain including various analysis components may be created using such tools. Typically, each component of the chain performs a specific task. The chain is executed on the predictive analysis tool for performing predictive analysis. However, users who do not have access to the predictive analysis tool may not be able to execute the chain to perform predictive analysis.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram of a system including a publishing module to publish a chain from a predictive analysis tool onto a database, according to an embodiment.

FIG. 2 illustrates the chain including a plurality of predefined components created using the predictive analysis tool, according to an embodiment.

FIG. 3 illustrates various procedures generated corresponding to various components of the chain, according to an embodiment.

FIG. 4 illustrates a context menu associated with a component and providing an option to publish the chain, according to an embodiment.

FIG. 5 illustrates an exemplary chain including two root components, according to an embodiment.

FIG. 6 illustrates another exemplary chain comprising multiple sub chains, according to an embodiment.

FIG. 7 is a block diagram illustrating an interface to access the database including the published chain, according to an embodiment.

FIG. 8 is a flow chart illustrating the steps to publish a chain from a predictive analysis tool onto a database, according to an embodiment.

FIG. 9 is a flow chart illustrating the steps to generate a procedure corresponding to a component of the chain, according to an embodiment.

FIG. 10 is a block diagram of an exemplary computer system, according to an embodiment.

### DETAILED DESCRIPTION

Embodiments of techniques for performing predictive analysis are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

The following terminology is used while disclosing various embodiments. One skilled in the art will recognize that these terms and examples they are used in are merely illustrative.

A component is a logical unit which performs a specific task or operation. Typically, the component is a software program (procedure) which performs a specific operation on data. The component may comprise a set of steps for performing the operation. The component can perform various operations on the data. For example, the component can retrieve or read data from a database table. In one embodiment, the various components are predefined and stored on a predictive analysis tool. A user can select the component of their choice and can execute the component to perform the specific operation on the data. In one embodiment, the component may be termed as an ‘analysis component’.

An analysis chain or a chain is a workflow for performing predictive analysis. The chain or the workflow is created on the predictive analysis tool. A user creates the chain based upon their requirement. The chain is created by selecting a plurality of components from the predictive analysis tool. The selected components are connected in a desired manner to create the desired chain. Therefore, the chain is a collection of various components linked together in a particular sequence which defines a flow of data. In some embodiments, the chain is created in a tree topology with one or more root components, one or more branch components, and one or more leaf components. In some embodiments, the chain is created as a directed acyclic graph. The chain is executed to perform predictive analysis. Each component of the chain is executed to perform a specific operation on data and generates an output. The output of one component may be passed as an input to another component, depending upon the connectivity of the components within the chain. The output generated by the one or more leaf components is the final output of the predictive analysis.

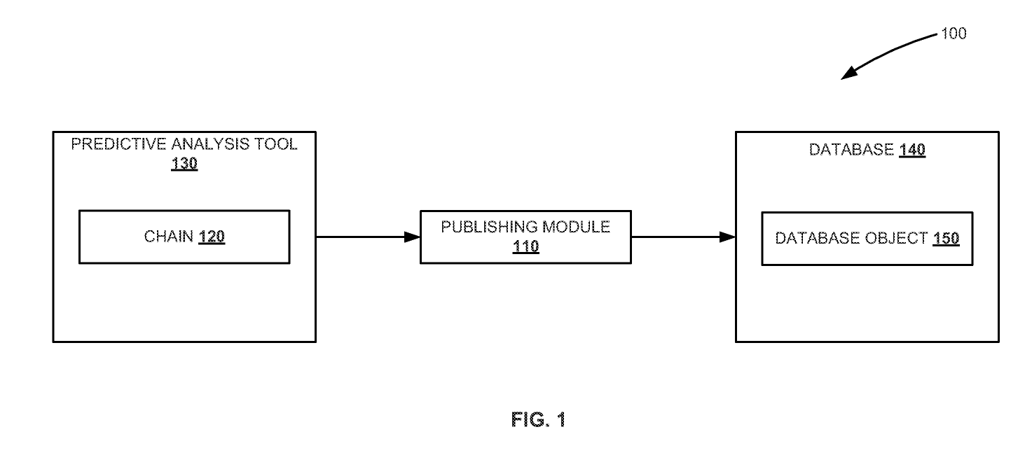

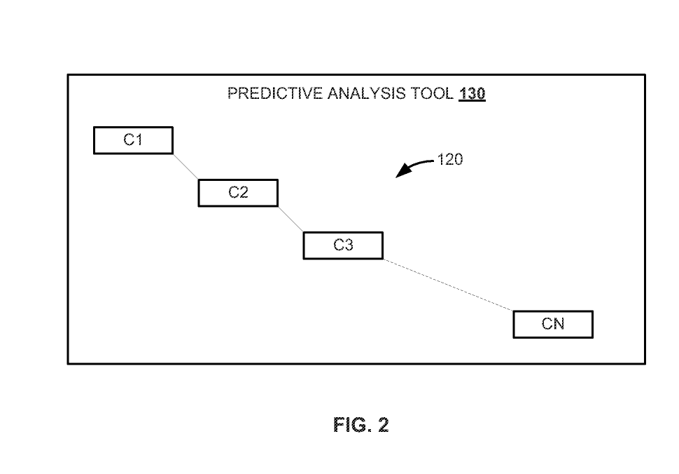

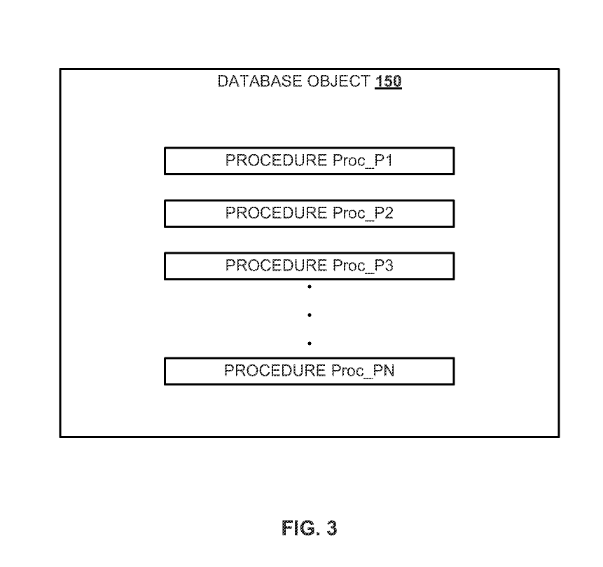

FIG. 1 illustrates one embodiment of a system 100 including a publishing module 110 for publishing an analysis chain or a chain 120 from a predictive analysis tool 130 onto a database 140. The chain 120 is created on the predictive analysis tool 130. The chain 120 comprises a plurality of predefined components, e.g., see FIG. 2 for C1-CN, connected together for performing predictive analysis. A command for publishing the chain 120 may be provided by a user. In one embodiment, the command for publishing the chain 120 may be provided upon the component CN (e.g., leaf component). Once the command is provided, the publishing module 110 publishes the chain 120 as a database object 150. The publishing module 110 generates procedures Proc_P1-Proc_PN (FIG. 3) corresponding to the components C1-CN of the chain 120. In one embodiment, the procedure Proc_P1-Proc_PN comprises structured query language (SQL) script of their corresponding component C1-CN. In one embodiment, the procedures Proc_P1-Proc_PN are integrated according to an order of connectivity of the components C1-CN within the chain 120. The procedures Proc_P1-Proc_PN are integrated to generate the database object 150 stored within the database 140. The stored database object 150 representing the chain 120 can be executed without accessing the predictive analysis tool 130.

Referring to FIG. 2, the chain 120 is created by the user such as an expert, a statistician, or an analyst on the predictive analysis tool 130. In one embodiment, the predictive analysis tool 130 may be any predictive analysis process designer tool. The chain 120 helps users in analyzing various data related to their business. The chain 120 includes the plurality of predefined analysis components, e.g., the components C1-CN.

Each component C1-CN represents a logical unit that performs a specific task. For example, the components C1-CN may each be a procedure or a set of steps to perform a specific task. In one embodiment, each component C1-CN may be one of a data source component which retrieves data from a database table, an algorithm component comprising various data mining algorithms, a data writer component which is used to export or write an output onto a data file, a data preprocessor component which performs preprocessing operations such as sorting, filtering, merging, etc. In one embodiment, the algorithm component is one of a clustering algorithm, a classification algorithm, and a regression algorithm, etc.

The components C1-CN are connected in a suitable data structure such as a linked list structure, a tree structure, etc., to generate the chain 120. Therefore, the chain 120 is preconfigured or predefined. The chain 120 may be published by the user. In one embodiment, publishing the chain 120 refers to storing the chain 120 upon a cloud or the database 140 in a suitable format. For example, publishing the chain 120 may refer to converting the chain 120 into the database object 150 and storing it onto the database 140. In one embodiment, any chain comprising a single leaf node or a single leaf component can be published as the database object 150.

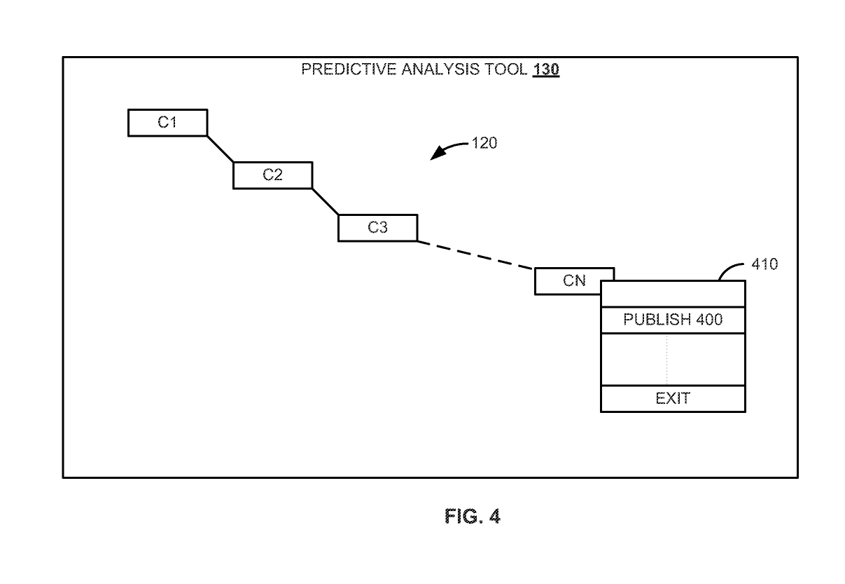

The user provides a command for publishing the chain 120. The command for publishing the chain 120 may be provided upon the leaf component CN. In one embodiment, as illustrated in FIG. 4, the command may be provided by selecting a ‘publish option’ 400 from a context menu 410 associated with the leaf component CN. In one embodiment, the context menu 410 may appear upon right clicking the leaf component CN. Once the command is provided upon the leaf component CN, the publishing module 110 identifies that the chain 120 is to be published.

In one embodiment, based upon the component CN upon which the command is provided, the chain 120 to be published is identified. The component upon which the command is provided is identified as the leaf component of the chain to be published. For example, if the user provides the command upon the component C3, the component C3 is identified as the leaf component of the chain to be published. The first component, e.g., C1, is identified as a root component of the chain to be published. The components, e.g., C2, in between the root component C1 and the leaf component C3 are identified as intermediate (branch) components of the chain to be published. Therefore, if the command is provided upon the component C3, the publishing module 110 identifies that the chain comprising the components from the root component to the leaf component (i.e., components C1-C3) is to be published.

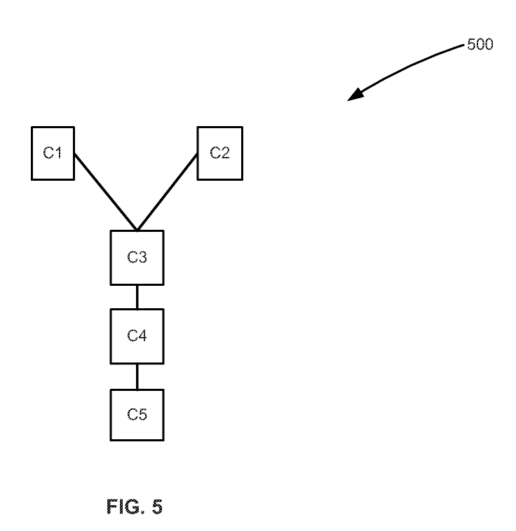

In one embodiment, the chain to be published may include multiple root components. For example, as illustrated in FIG. 5, a chain 500 to be published includes two root components C1 and C2. The leaf component is the component upon which typically the command for publishing the chain 500 is provided. Therefore, there is always a single leaf component. If the command for publishing the chain is provided upon the component C5, the publishing module 110 identifies that the chain 500 comprising the root components C1 and C2, the intermediate components C3 and C4, and the leaf component C5 is to be published. In one embodiment, if the user provides the command upon the component C3, then the publishing module 110 identifies that the chain comprising the root components C1 and C2 and the leaf component C3 is to be published.

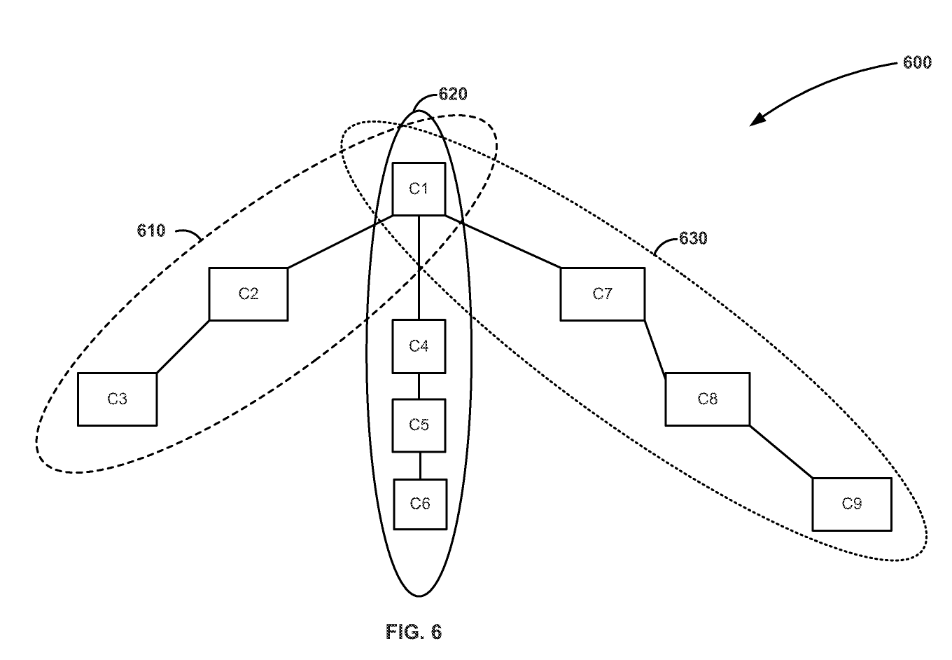

In one embodiment, as illustrated in FIG. 6, a complex chain 600 including the components C1-C9 in a tree structure may be published as multiple chains. The complex chain 600 includes three sub chains 610-630. Each sub chain 610-630 includes their respective leaf components C3, C6, and C9. The chains 610-630 having the leaf component C3, C6, and C9, respectively, can be published as separate database objects. The command for publishing the chains 610-630 is provided upon their respective leaf component C3, C3, C6, and C9. For example, if the command is provided upon the component C3, the publishing module 110 identifies that the chain 610 is to be published.

Once the chain, e.g., the chain 610, to be published is identified, the publishing module 110 reads a parameterized SQL script of each component C1-C3 of the chain 610. The parameterized SQL script includes one or more variables or parameters. A value of a parameter may be provided by the user. In one embodiment, the publishing module 110 prompts the user to provide the values of the parameters. Once the values of the parameters are provided, the publishing module 110 replaces the parameters with their respective values. The parameters are replaced by their respective values within the parameterized SQL script of the components C1-C3 to generate procedures Proc_P1-Proc_P3 corresponding to the components C1-C3.

In one example, the component C1 of the chain 610 may be the data source component that includes the parameterized SQL script for retrieving data from any database such as the database 140. The parameterized SQL script for the component C1 may be as shown below:

### INSERT INTO % OUTPUT_TABLE_NAME % (SELECT % INPUT_COLS % FROM % INPUT TABLE %)

The above parameterized SQL script of the component C1 includes the parameters such as INPUT_COLS and INPUT TABLE. The parameterized SQL script of the component C1 generates an output table. The output table is represented as “OUTPUT_TABLE_NAME” in the parameterized SQL script. The output table includes one or more columns “INPUT_COLS” from the database table “INPUT_TABLE”. The output table “OUTPUT_TABLE_NAME,” the database table “INPUT_TABLE,” and the columns “INPUT_COLS” are the parameters in the above parameterized SQL script of the component C1. The value of the parameters may be provided by the user. In one embodiment, the value of some parameters such as “OUTPUT_TABLE_NAME” is internally assigned or automatically provided by the publishing module 110.

In one embodiment, the publishing module 110 prompts the user to provide the values of the parameters namely “INPUT_TABLE” and “INPUT_COLS”. In one embodiment, the values of the parameters may be provided through a property window (not shown). The user may select, e.g., double clicks, the component C1 to display the property window related to the component C1. The property window includes various parameters related to the component C1. For example, the property window may include the parameters “INPUT_TABLE” and “INPUT_COLS” included within the parameterized SQL script of the component C1. The parameters “INPUT_TABLE” and “INPUT_COLS” may have default values, e.g., Table X and ALL columns. The default values of the parameters may be altered or edited by the user.

For example, the user may provide the value of “INPUT_TABLE” as “Table 1”. The Table 1 as shown below may be a table from the database 140:

TABLE 1

| | | | Sales Revenue |
|---|---|---|---|
| Company Name | Product Model | Quantity Sold | (million) |
| A | abc | 22867 | 219.7 |
| B | xyz | 11197 | 113.4 |
| D | I2 | 62745 | 618.2 |
| C | ABD | 945 | 8.9 |
| F | hx | 8546 | 11.6 |
| D | yx | 21659 | 216.7 |
| D | Rdb | 12745 | 118.2 |
| E | mnr | 558 | 6 |
| D | U3 | 42743 | 416.3 |
| B | acs | 11067 | 117.6 |
| C | mrt | 11174 | 114.8 |
| D | ydb | 11645 | 116.3 |
| C | rdv | 9781 | 113.2 |
| D | Y4 | 19600 | 100.3 |
| D | I9 | 10007 | 99 |

The user may also provide the value of the parameter “INPUT_COLS” as columns of Table 1 that is to be selected. For example, the user may provide the value of “INPUT_COLS” as “company name, product model, sales revenue”. The publishing module 110 may automatically provide the name of the parameter “OUTPUT_TABLE_NAME” as “output_table_{—}1”. The publishing module 110 substitutes the parameters with their respective values in the parameterized SQL script of the component C1 to generate a procedure Proc_P1 corresponding to the component C1, as shown below:

### Proc_P1:

BEGIN
{ INSERT INTO output_table_1 (SELECT company name,
product model, sales revenue FROM Table 1)
}
END

Once the procedure Proc_P1 is generated, the publishing module 110 generates a procedure Proc_P2 corresponding to the component C2 of the chain 610. The component C2 may be a filtering logic which is meant for filtering the information of the output_table_{—}1 generated by the component C1. The component C2 filters the output_table_based upon some parameters. For example, the component C2 filters data of the output_table_{—}1 based upon the value of the column “company name” as “company name=D”. The parameterized SQL script of the component C2 may be as shown below:

### INSERT INTO % OUTPUT_TABLE_NAME % (SELECT % INPUT_COLS % FROM % INPUT_TABLE_NAME % WHERE % COLUMN_NAME %=% VALUE %)

The above parameterized SQL script of the component C2 generates the output “OUTPUT_TABLE_NAME”. The “OUTPUT_TABLE_NAME” includes one or more columns “INPUT_COLS” having “COLUMN_NAME=VALUE” from the “INPUT_TABLE_NAME”. The value of the parameters “INPUT_COLS” and “COLUMN_NAME=VALUE” may be provided by the user. For example, the user may provide the value of “INPUT_COLS” as {company name, product model, sales revenue} and the value of the “COLUMN_NAME=VALUE” as {company=D}. In one embodiment, the publishing module 110 internally assigns a name of the “OUTPUT_TABLE_NAME” as output_{—}2. The publishing module 110 automatically replaces the parameter “INPUT_TABLE_NAME” with the output of the component C1, i.e., output_table_{—}1.

The publishing module 110 replaces the parameters “OUTPUT_TABLE_NAME,” “INPUT_COLS,” “INPUT_TABLE_NAME,” and “COLUMN_NAME=VALUE” in the parameterized SQL script of the component C2 with output_{—}2, {company name, product model, sales revenue}, output_table_{—}1, and {company=D}, respectively, to generate the procedure Proc_P2 corresponding to the component C2, as shown below:

### Proc_P2:

BEGIN
{ INSERT INTO output_2 ( SELECT company name, product model,
sales revenue
FROM output_table_1 WHERE “company name”= D)
}
END

Once the procedure Proc_P2 is generated, the publishing module 110 generates a procedure Proc_P3 corresponding to the component C3. The component C3 may be the clustering algorithm to group input data into different groups or clusters. The parameterized SQL script of the component C3 (CLUSTERING) may be as shown below:

CREATE PROCEDURE CLUSTERING ( IN dataset, IN nClusters , OUT
outTableName)
LANGUAGE SQLSCRIPT READS SQL DATA AS
BEGIN
{
pal::kmeans(dataset, nClusters, outTableName);
}
END
CALL CLUSTERING (%INPUT_TABLE_NAME%,
%NUMBER_OF_CLUSTERS%,
%OUTPUT_TABLE%).

In the above parameterized SQL script, ‘IN’ indicates ‘input,’ ‘OUT’ indicates ‘output,’ and ‘dataset’ indicates the input table upon which clustering is to be performed. For example, the output of the component C2 (output_{—}2) may be the dataset or input table for the component C3. ‘nClusters’ indicates a number of clusters or groups the ‘dataset’ is to be divided into and the ‘outTableName’ is the output table generated by the component C3 as the result of clustering. The function “pal::kmeans(dataset, nClusters, outTableName)” is an exemplary function used to perform clustering using a kmeans algorithm. The function clusters the ‘dataset’ into ‘nClusters’ to generate the output table ‘outTableName’. The function may vary depending upon the type of the database implemented. The component C3 (CLUSTERING) may be called by using “CALL CLUSTERING (% INPUT_TABLE_NAME %, % NUMBER_OF_CLUSTERS %, % OUTPUT_TABLE %)”.

The component C3 is called by providing values of three parameters namely ‘INPUT_TABLE_NAME,’ ‘NUMBER_OF_CLUSTERS,’ and ‘OUTPUT_TABLE’. ‘INPUT_TABLE_NAME’ corresponds to ‘dataset’. In one embodiment, the value of the parameter ‘INPUT_TABLE_NAME’ is automatically provided by the publishing module 110. For example, the publishing module 110 may pass the output of component C2 (output_{—}2) as the input ‘INPUT_TABLE_NAME’ to the component C3. ‘NUMBER_OF_CLUSTERS’ corresponds to ‘nCLusters’. The value of the parameter ‘NUMBER_OF_CLUSTERS’ may be provided by the user. For example, the user may provide the ‘NUMBER_OF_CLUSTERS’ as “3”. ‘OUTPUT_TABLE’ corresponds to ‘outTableName’. The value of the parameter ‘OUTPUT_TABLE’ is provided by the user. For example, the user may provide the value of the ‘OUTPUT_TABLE’ as ‘final_table’.

The publishing module 110 generates the procedure Proc_P3 corresponding to the component C3. In one embodiment, the procedure Proc_P3 is generated as:

Proc_P3 (IN dataset, IN nClusters, OUT outTableName)

BEGIN
{
pal::kmeans(dataset, nCLusters, outTableName);
}

### END

Once the procedures Proc_P1, Proc_P2, and Proc_P3 are generated, the publishing module 110 integrates the procedures Proc_P1, Proc_P2, and Proc_P3 to generate the database object 150. In one embodiment, integration defines a relationship or the order of connectivity between the procedures Proc_P1, Proc_P2, and Proc_P3. The connectivity may be a functional connectivity. In one embodiment, the procedures Proc_P1, Proc_P2, and Proc_P3 are connected according to the order of connectivity of the components C1-C3 within the chain 610. For example, the procedures may be integrated such that the output of the procedure Proc_P1 is provided as the input to the procedure Proc_P2 and the output of the procedure Proc_P2 is provided as the input to the procedure Proc_P3. Alternately, the procedures Proc_P1-Proc_P3 are integrated to define the order of execution as Proc_P1->Proc_P2->Proc_P3 based upon the order of execution of the components C1->C2->C3 within the chain 610.

The procedures Proc_P1, Proc_P2, and Proc_P3 are integrated to generate the database object 150. The database object 150 may be as shown below:

BEGIN
{
call “Proc_P1” (output_table_1);
call “Proc_P2” (:output_table_1, output_2);
call “Proc_P3”(:output_2, 3, final_table);
}
END

The above database object 150 includes the procedures Proc_P1-Proc_P3 in the order of execution Proc_P1->Proc_P2->Proc_P3. A colon (:) prefixed to the output_table_{—}1 in the call procedure “Proc_P2” indicates that the output_table_{—}1 is being provided as the input to the procedure Proc_P2. Similarly, the colon (:) prefixed to the output_{—}2 in the call procedure “Proc_P3” indicates that the output_{—}2 is being provided as the input to the procedure Proc_P3.

In one embodiment, the database object 150 may be generated by executing a command shown below:

CREATE PROCEDURE “database object 150”
(OUT final_table “final_table_type”)
LANGUAGE SQLSCRIPT READS SQL DATA WITH OUTPUT
VIEW “output_view”
AS
BEGIN
{
call “Proc_P1” (output_table_1);
call “Proc_P2” (:output_table_1, output_2);
call “Proc_P3”(:output_2, 3, final_table);
}
END

The above command generates the database object 150. “OUT” indicates output. The output generated by the database object 150 is “final_table” which is also the output generated by the last procedure Proc_P3 of the database object 150. The “final_table” is a runtime object which is generated on the fly. The “final_table” is of a data type “final_table_type”. The “final_table_type” is the data type defined by the publishing module 110. For example, the “final_table_type” may be a type of a table defined as (“company name” varchar[100], “product model” varchar[100], “sales revenue” double, “cluster number” int[100]). The table includes four columns namely the “company name” which is the alphanumeric value of maximum 100 characters (i.e., varchar[100]), the “product model” which is also the alphanumeric value of maximum 100 characters (i.e., varchar[100]), the “sales revenue” which is the floating numeral value (i.e., double), and the “cluster number” which is an integer of maximum 100 characters (i.e., int[100]).

“LANGUAGE SQLSCRIPT” in the command indicates that a language used within the database object 150 is the SQL script. “READS SQL DATA” in the command indicates that the database object 150 is the read-only procedure that only reads SQL data without editing it. “WITH OUTPUT VIEW “output_view”” indicates that the database object 150 is created along with the ‘output_view’ which is a tabular database object. The database object 150 is accessed or executed through the ‘output_view’. The ‘output_view’ is accessible by anyone using direct SQL statements like SELECT statements, etc. The ‘output_view’ when accessed invokes and executes the database object 150.

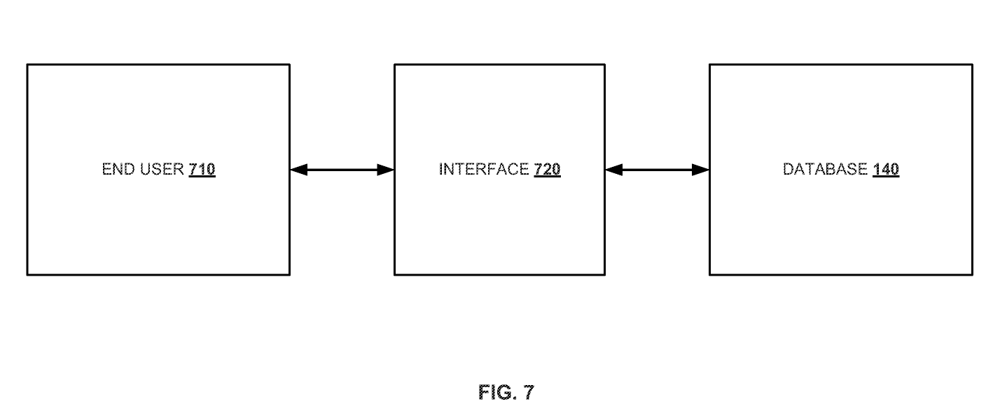

The database object 150 and the ‘output_view’ are stored within the database 140. In one embodiment, the database 140 is an in-memory database. In one embodiment, as illustrated in FIG. 7, a client or an end user 710 may access the database 140 for executing the database object 150. The end user 710 accesses the database 140 through an interface 720. In one embodiment, the interface 720 is an open database connectivity (ODBC) interface. Once the database 140 is accessed, the end user 710 can write the SQL statements to access the output view to execute the database object 150.

For example, the end user 710 may write a simple SELECT statement to access the ‘output_view’ to execute the database object 150. The ‘output_view’ invokes and executes the database object 150 to generate the final_table. In an example, the end user 710 may write the below SELECT statement to execute the database object 150 through the output_view:

SELECT*FROM output_view WHERE ‘sales revenue’>“100”

Based upon the above ‘SELECT statement,’ the database 140 accesses the ‘output_view’. The output_view invokes and executes the database object 150 shown below:

BEGIN
{
call “Proc_P1” (output_table_1);
call “Proc_P2” (:output_table_1, output_2);
call “Proc_P3”(:output_2, 3, final_table);
}
END

Based upon the database object 150, the procedure Proc_P1 is executed first. Referring back, the procedure Proc_P1 is “INSERT INTO output_table_{—}1 (SELECT company name, product model, sales revenue FROM Table 1)”. The procedure Proc_P1 is executed to generate the output_table_{—}1 shown below as Table 2:

TABLE 2

| Company Name | Product Model | Sales Revenue (million) |
|---|---|---|
| A | abc | 219.7 |
| B | xyz | 113.4 |
| D | I2 | 618.2 |
| C | ABD | 8.9 |
| F | hx | 11.6 |
| D | yx | 216.7 |
| D | Rdb | 118.2 |
| E | mnr | 6 |
| D | U3 | 416.3 |
| B | acs | 117.6 |
| C | mrt | 114.8 |
| D | ydb | 116.3 |
| C | rdv | 113.2 |
| D | Y4 | 100.3 |
| D | I9 | 99 |

The output table 1 is passed as input to the procedure Proc_P2. Referring back, the procedure Proc_P2 is “INSERT INTO output_{—}2 (SELECT company name, product model, sales revenue FROM output_table_{—}1 WHERE “company name”=D)”, The procedure Proc_P2 is executed to generate the output_{—}2. In one embodiment, the output_{—}2 may be the Table 3 as shown below:

TABLE 3

| Company Name | Product Model | Sales Revenue (million) |
|---|---|---|
| D | I2 | 618.2 |
| D | yx | 216.7 |
| D | Rdb | 118.2 |
| D | U3 | 416.3 |
| D | ydb | 116.3 |
| D | Y4 | 100.3 |
| D | I9 | 99 |

The output_{—}2 is passed as input to the procedure Proc_P3. Referring back, the procedure Proc_P3 is executed to generate the final_table. The final_table may be shown as Table 4 below:

TABLE 4

| | | | Cluster |
|---|---|---|---|
| Company Name | Product Model | Sales Revenue (million) | Number |
| D | I2 | 618.2 | 1 |
| D | yx | 216.7 | 2 |
| D | Rdb | 118.2 | 3 |
| D | U3 | 416.3 | 1 |
| D | ydb | 116.3 | 3 |
| D | Y4 | 100.3 | 3 |
| D | I9 | 99 | 3 |

Therefore, the output_view is accessed to execute the database object 150 to generate the final_output (Table 4). Based upon the user's SELECT statement (SELECT*FROM output_view WHERE ‘sales revenue’>“100”), all those rows of Table 4 are selected whose sales revenue value is greater than 100. The symbol ‘*’ in the SELECT statement identifies that all the columns of Table 4 has to be selected. Therefore, an output displayed to the end user 710 may be shown as Table 5 below:

TABLE 5

| | | | Cluster |
|---|---|---|---|
| Company Name | Product Model | Sales Revenue (million) | Number |
| D | I2 | 618.2 | 1 |
| D | yx | 216.7 | 2 |
| D | Rdb | 118.2 | 3 |
| D | U3 | 416.3 | 1 |
| D | ydb | 116.3 | 3 |
| D | Y4 | 100.3 | 3 |

In another example, if the SELECT statement written by the end user 710 is (SELECT product model, sales revenue FROM output_view WHERE ‘cluster number’=“3”), then the column ‘product name’ and ‘sales revenue’ are selected from Table 4 and all the rows whose cluster number is 3 are selected. Therefore, the output displayed to the end user 710 may be shown as Table 6 below:

TABLE 6

| Product Model | Sales Revenue (million) |
|---|---|
| Rdb | 118.2 |
| ydb | 116.3 |
| Y4 | 100.3 |
| I9 | 99 |

Therefore, a suitable SELECT statement may be written by the end user 710 to invoke and execute the database object 150 for generating the output according to their requirement.

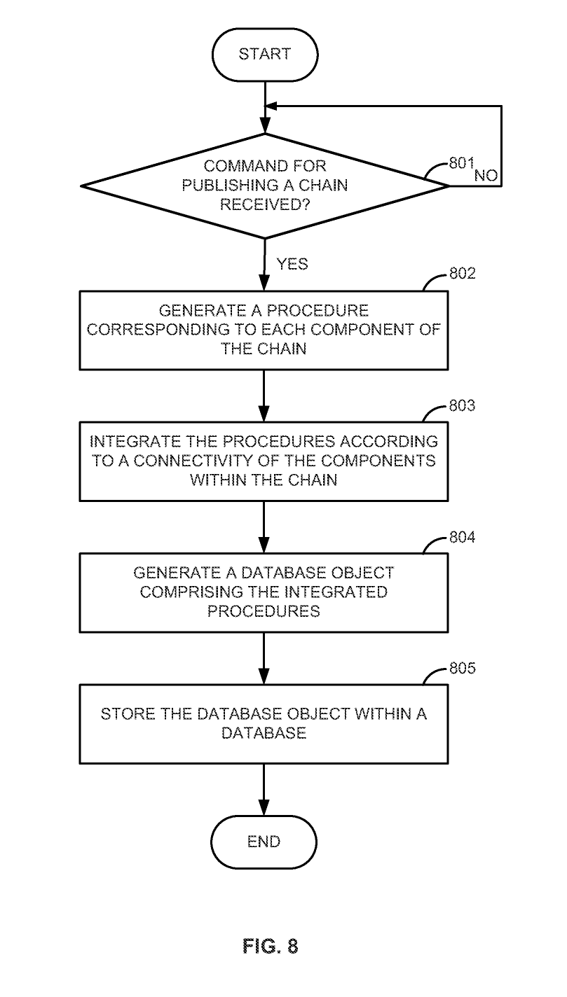

FIG. 8 is a flowchart illustrating a method for publishing the chain 120 onto the database 140, according to an embodiment. The chain 120 is published upon receiving the command from the user. At step 801, it is determined whether the command for publishing the chain 120 is received. In one embodiment, the command for publishing the chain 120 is provided upon the component CN (leaf component). The command may be provided by selecting the ‘publish option’ 400 from the context menu 410 associated with the component CN. If the command for publishing the chain 120 is received (step 801: YES), the publishing module 110 generates the procedures Proc_P1-Proc_PN corresponding to the components C1-CN of the chain 120 at step 802. The procedures Proc_P1-Proc_PN are integrated according to the connectivity of the components C1-CN within the chain 120 at step 803. The database object 150 including the integrated procedures Proc_P1-Proc_PN is generated at step 804. The database object 150 is stored within the database 140 at step 805. The database object 150 representing the chain 120 can be accessed or executed by the end user 710 having the access to the database 140.

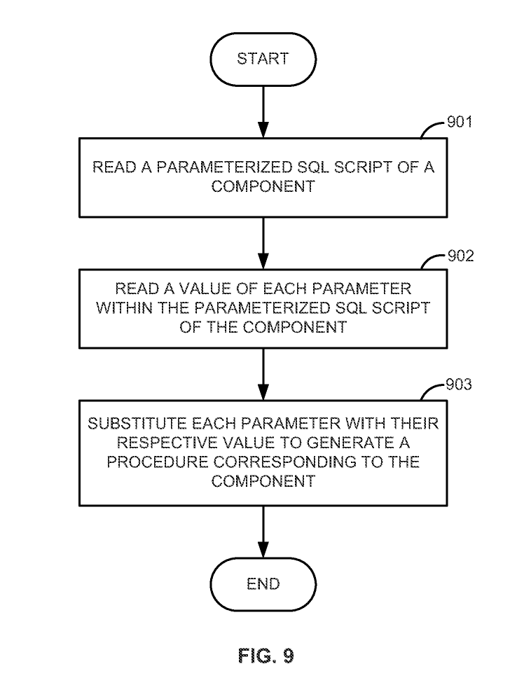

FIG. 9 is a flowchart illustrating a method for generating the procedure, e.g., the procedure Proc_P1 corresponding to the component C1, according to an embodiment. The publishing module 110 generates the procedure Proc_P1 corresponding to the component C1 upon receiving the command for publishing the chain, e.g., the chain 120. The parameterized SQL script of the component C1 is read at step 901. The parameterized SQL script includes the one or more variables or parameters. The values of the parameters are read at step 902. In one embodiment, the values of the one or more parameters are provided by the user. In one embodiment, the values of some parameters are automatically provided by the publishing module 110. Once the values of the parameters are read, the publishing module 110 substitutes the parameters with their corresponding value within the parameterized SQL script of the component C1 to generate the procedure Proc_P1 at step 903. Similarly, the procedures Proc_P2-Proc_PN are generated corresponding to the component C2-CN. The procedures Proc_P1-Proc_PN are integrated to generate the database object 150. The database object 150 representing the chain 120 can be executed from various non-predictive analysis tools using simple SELECT statements.

Embodiments described above enable performing predictive analysis without accessing predictive analysis tools. A chain may be created by an expert for performing predictive analysis upon a predictive analysis tool. The chain can be published from the predictive analysis tool onto a database. The chain can be published as a database object such as a result view or an output view. The published chain can be executed by anyone having an access to the database. Therefore, the predictive analysis can be performed by anyone or from any tool having the access to the database. Further, a simple SELECT statement may be written for accessing or executing the database object (published chain) to perform predictive analysis. Additionally, if the chain is published onto an in-memory database, then the predictive analysis can be performed quickly which enhances speed and makes system more efficient. Finally, the system saves resources which might be wasted in accessing the predictive analysis tool for performing predictive analysis.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

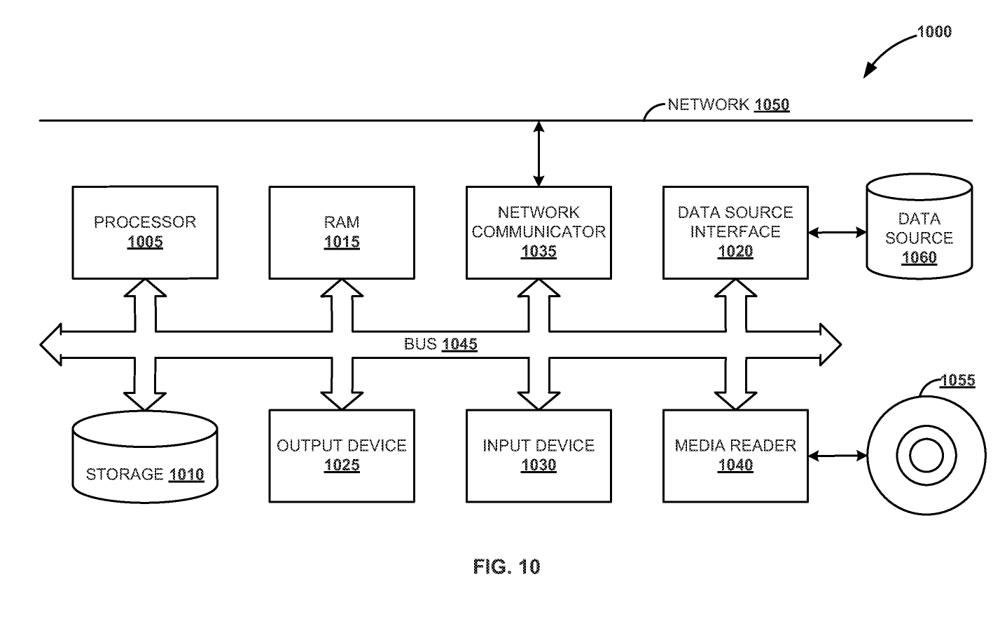

FIG. 10 is a block diagram of an exemplary computer system 1000. The computer system 1000 includes a processor 1005 that executes software instructions or code stored on a computer readable storage medium 1055 to perform the above-illustrated methods. The processor 1005 can include a plurality of cores. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. According to some embodiments, such as some in-memory computing system embodiments, the RAM 1015 can have sufficient storage capacity to store much of the data required for processing in the RAM 1015 instead of in the storage 1010. In some embodiments, all of the data required for processing may be stored in the RAM 1015. The stored instructions may be further compiled to generate other representations of the instructions and dynamically stored in the RAM 1015. The processor 1005 reads instructions form the RAM 1015 and performs actions as instructed. According to one embodiment, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an ERP system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments are to be determined by the following claims, which are to be interpreted in accordance with established doctrines of claim construction.

What is claimed is:

1. An article of manufacture including a non-transitory computer readable storage medium to tangibly store instructions, which when executed by one or more computers in a network of computers causes performance of operations comprising:
receiving a command for publishing an analysis chain comprising a plurality of analysis components connected together to perform predictive analysis;
based upon the command, generating procedures for the plurality of analysis components;
integrating the generated procedures according to an order of connectivity of the plurality of analysis components in the analysis chain;
generating a database object comprising the integrated procedures; and
storing the database object within a database.

2. The article of manufacture of claim 1, wherein an analysis component comprises one of a data source component, an algorithm component, a data writer component, and a data preprocessor component.

3. The article of manufacture of claim 1, wherein each analysis component comprises a parameterized structured query language (SQL) script.

4. The article of manufacture of claim 3, wherein generating the procedures for the plurality of analysis components comprises:
reading the parameterized SQL script of the plurality of analysis components, wherein the parameterized SQL script includes one or more parameters;
reading a value of the one or more parameters, wherein the value of the one or more parameters is provided by a user; and
substituting the one or more parameters with their respective values.

5. The article of manufacture of claim 1, wherein the database comprises an in-memory database.

6. The article of manufacture of claim 1, wherein the analysis chain comprises:
a root component; and
a leaf component on which the command for publishing the analysis chain is initiated.

7. The article of manufacture of claim 6, wherein the analysis chain further comprises one or more analysis components between the root component and the leaf component.

8. The article of manufacture of claim 1, wherein the database is configured to perform the operations comprising:
receiving a command for executing the stored database object;
executing the stored database object to generate an output; and
displaying the output.

9. The article of manufacture of claim 8, wherein the command for executing the stored database object comprises a SELECT structured query language (SQL) statement.

10. The article of manufacture of claim 8, wherein generating the database object comprises generating an output view and wherein the command for executing the stored database object is provided using the output view.

11. A method for performing a predictive analysis, the method comprising:
receiving a command for publishing an analysis chain comprising a plurality of analysis components connected together to perform the predictive analysis;
based upon the command, generating procedures for the plurality of analysis components;
integrating the generated procedures according to an order of connectivity of the plurality of analysis components in the analysis chain;
generating a database object comprising the integrated procedures; and
storing the database object within a database.

12. The method of claim 11, wherein generating the procedures for the plurality of analysis components comprises:
reading the parameterized SQL script of an analysis component of the plurality of analysis components, wherein the parameterized SQL script includes one or more parameters;
reading a value of the one or more parameters, wherein the value of the one or more parameters is provided by a user; and
substituting the one or more parameters with their respective values.

13. The method of claim 11 further comprising identifying a leaf component of the analysis chain as a component where the command for publishing the analysis chain is initiated.

14. The method of claim 11 further comprising:
receiving a command for executing the stored database object;
executing the stored database object to generate an output; and
displaying the output.

15. A computer system for performing a predictive analysis, the computer system comprising:
a memory to store program code; and
a processor communicatively coupled to the memory, the processor configured to execute the program code to:
receive a command for publishing an analysis chain comprising a plurality of analysis components connected together to perform the predictive analysis;
based upon the command, generate procedures for the plurality of analysis components;
integrate the generated procedures according to an order of connectivity of the plurality of analysis components in the chain;
generate a database object comprising the integrated procedures; and
store the database object within a database.

16. The computer system of claim 15, wherein the program code to generate the procedures for the plurality of analysis components, further comprises program code to:
read the parameterized SQL script of an analysis component of the plurality of analysis components, wherein the parameterized SQL script includes one or more parameters;
read a value of the one or more parameters, wherein the value of the one or more parameters is provided by a user; and
substitute the one or more parameters with their respective values.

17. The computer system of claim 15, wherein the processor is further configured to execute the program code to identify:
a root component of the analysis chain; and
a leaf component of the analysis chain, wherein the leaf component of the analysis chain is identified as a component on which a command for publishing the chain is initiated.

18. The computer system of claim 17, wherein the processor is further configured to execute the program code to identify one or more branch components as one or more analysis components between the root component and the leaf component.

19. The computer system of claim 15, wherein the database is configured to:
receive a command to execute the stored database object;
execute the stored database object to generate an output; and
display the output.

20. The computer system of claim 19, wherein the command to execute the stored database object comprises a SELECT structured query language (SQL) statement.
